(19) United States
(12) Patent Application Publication
(10) Pub. No.: US 2004/0013165 A1
(43) Pub. Date: Jan. 22, 2004

(54) Method and device for correcting a temperature signal

(76) Inventors: Holger Plote, Fellbach-Oeffingen (DE); Andreas Krautter, Steinheim (DE); Michael Walter, Kornwestheim (DE)

Correspondence Address: KENYON & KENYON, ONE BROADWAY, NEW YORK, NY, 10004, US

(21) Appl. No.: 10/258,102

(22) PCT Filed: Feb. 7, 2002
(86) PCT No.: PCT/DE02/00444

(30) Foreign Application Priority Data
Feb. 21, 2001 (DE) 101 08 181.2

(51) Int. Cl. G01K 1/08; G01K 1/14

(52) U.S. Cl. 374/172; 374/144; 374/1

(57) ABSTRACT

Described are a device and a method for correcting a temperature signal, in particular, a temperature signal which characterizes the temperature of the gases which are fed to the internal combustion engine and/or which are emitted by the of an internal combustion engine. A first correction takes into account the response of the sensor. A second correction takes into account the dynamic behavior of the internal combustion engine and/or of the associated components.

### FIELD OF THE INVENTION

The present invention relates to a method and a device for correcting a temperature signal.

For controlling and/or monitoring so-called “exhaust gas aftertreatment systems”, one or even more temperature sensors are provided in the exhaust branch. Usual sensors are slow because of their measuring principle. In the dynamic engine operation, therefore, the measured temperature profile features a time delay with respect the actual temperature profile. The dynamic inertia of the sensor or of the overall system causes problems, in particular, when monitoring and/or controlling variables. In monitoring, it is particularly problematic that the delayed temperature signal is compared to other quantities which are measured with dynamically better sensors or calculated from the signals thereof.

### ADVANTAGES OF THE INVENTION

By subjecting the temperature signal to a first correction which takes into account the response of the sensor and to a second correction which takes into account the dynamic behavior of the internal combustion engine and/or of the associated components, it is possible for the accuracy of the temperature signal to be markedly improved. In particular, the dynamic behavior of the signal during changes of an operating parameter is improved.

It is particularly advantageous, if it is possible to select a correction value which is used to correct, in particular, the response of the sensor. This correction value is designed so as to minimize the deviations between the temperature signal and the actual temperature.

This correction value is preferably selectable as a function of an injected fuel mass, a temperature and/or as a function of an air quantity. For this, in particular the output signal of a temperature sensor and/or of an air-flow sensor is/are used. These variables have the greatest influence on the response of the sensor. Alternatively to the air quantity, it is also possible to use a variable which characterizes the exhaust volume or, in a simplified embodiment, the speed of the internal combustion engine.

It is particularly advantageous, if it is possible to select a correction value in such a manner that the delay time of the sensor is corrected during changes of the operating state (QK, ML).

Advantageous and suitable embodiments and refinement of the present invention are characterized in the subclaims.

### DRAWING

In the following, the present invention will be explained with reference to the embodiments shown in the drawing.

FIG. 1 shows a block diagram of an exhaust gas aftertreatment system;

FIGS. 2 through 5 depict different embodiments of the procedure according to the present invention; and

FIG. 6 shows different signals.

### DESCRIPTION OF THE EXEMPLARY EMBODIMENTS

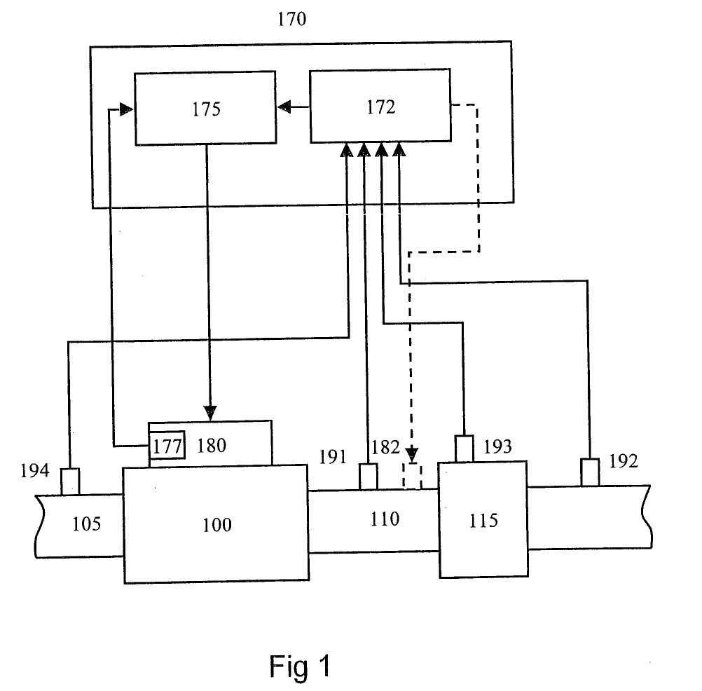

FIG. 1 shows the essential elements of an exhaust gas aftertreatment system of an internal combustion engine. The internal combustion engine is denoted by 100. It is supplied with fresh air via a fresh-air pipe 105. The exhaust gases of the internal combustion engine 100 get into the environment via an exhaust pipe 110. An exhaust gas aftertreatment system 115 is arranged in the exhaust pipe. This can be a catalytic converter and/or a particulate filter. Moreover, it is possible to provide several catalytic converters for different pollutants or combinations of at least one catalytic converter and a particulate filter.

Also provided is a control unit 170 which includes at least one engine control unit 175 and an exhaust gas aftertreatment control unit 172. Engine control unit 175 applies control signals to a fuel metering system 180. Exhaust gas aftertreatment control unit 172 applies control signals to engine control unit 175 and, in one embodiment, to a final control element 182 which is arranged in the exhaust pipe upstream of the exhaust gas aftertreatment system or in the exhaust gas aftertreatment system.

Moreover, it is possible to provide various sensors which feed signals to the exhaust gas aftertreatment control unit and to the engine control unit. Thus, provision is made for at least one first sensor 194 which delivers signals characterizing the state of the air which is fed to the internal combustion engine. A second sensor 177 delivers signals characterizing the state of fuel metering system 180. At least one third 191 delivers signals characterizing the state of the exhaust gas upstream of the exhaust gas aftertreatment system. At least one fourth sensor 193 delivers signals characterizing the state of exhaust gas aftertreatment system 115. Moreover, at least one sensor 192 can deliver signals characterizing the state of the exhaust gases downstream of the exhaust gas aftertreatment system. Preferably used are sensors which measure temperature values and/or pressure values.

The output signals of first sensor 194, of third sensor 191, of fourth sensor 193 and of fifth sensor 192 are preferably applied to exhaust gas aftertreatment control unit 172. The output signals of second sensor 177 are preferably applied to engine control unit 175. It is also possible to provide further sensors (not shown) which characterize a signal with respect to the driver's command or further ambient conditions or engine operating states.

It is particularly advantageous if the engine control unit and the exhaust gas aftertreatment control unit form one structural unit. However, provision can also be made for these to be designed as two spatially separated control units.

The procedure according to the present invention is preferably used to control internal combustion engines, in particular, in the case of internal combustion engines featuring an exhaust gas aftertreatment system. It can be used, in particular, in the case of exhaust gas aftertreatment systems featuring a combination of a catalytic converter and a particulate filter. Moreover, it is usable in systems which are equipped only with a catalytic converter.

On the basis of the available sensor signals, engine control 175 calculates control signals to be applied to fuel metering system 180. The fuel metering system then meters the corresponding fuel quantity to internal combustion engine 100. During combustion, particulates can arise in the exhaust gas. These are trapped by the particulate filter in exhaust gas aftertreatment system 115. In the course of operation, corresponding amounts of particulates accumulate in particulate filter 115. This impairs the functioning of the particulate filter and/or of the internal combustion engine. Therefore, provision is made for a regeneration process to be initiated at certain intervals or when the particulate filter has reached a certain loading condition. This regeneration can also be referred to as special operation.

The loading condition is detected, for example, on the basis of different sensor signals. To this end, it is possible, for example, to evaluate the pressure difference between the input and the output of particulate filter 115. Moreover, it is convenient to determine the loading condition as a function of different temperature and/or different pressure values. In addition, it is possible to use further variables to calculate or simulate the loading condition. A suitable procedure is known, for example, from German Patent DE 199 06 287.

When the exhaust gas aftertreatment control unit detects the particulate filter to have reached a certain loading condition, then the regeneration is initialized. To regenerate the particulate filter, different possibilities are available. Thus, first of all, provision can be made for certain substances to be fed to the exhaust gas via final control element 182 which then cause a corresponding reaction in exhaust gas aftertreatment system 115. These additionally metered substances cause, inter alia, an increase in temperature and/or an oxidation of the particulates in the particulate filter. Thus, for example, provision can be made for fuel and/or an oxidizing agent to be supplied via final control element 182.

In one embodiment, provision can be made that a corresponding signal is transmitted to engine control unit 175 and that the engine control unit carries out a so-called “post-injection”. The post-injection makes it is possible to selectively introduce hydrocarbons into the exhaust gas which contribute to the regeneration of the exhaust gas aftertreatment system 115 via an increase in temperature.

Usually, provision is made to determine the loading condition on the basis of different variables. By comparison to a threshold value, the different states are detected and the regeneration is initiated as a function of the detected loading condition.

In the embodiment described below, sensor 191 is designed as a temperature sensor. This sensor delivers a voltage signal which is converted to the corresponding temperature value via a calibration curve. This temperature value is then used to control the internal combustion engine and/or the exhaust gas aftertreatment system.

During the procedure according to the present invention, this value is modified by determining a correction value K from dynamically fast variables. In particular, injected fuel quantity QK, air mass ML, or variables characterizing these quantities are used for this purpose. In this context, mainly two effects are taken into account. These are, first of all, the lag characteristic of the sensor itself and/or the lag characteristic of the overall system.

The sensor behavior itself is determined, inter alia, by the heat transfer coefficient, that is, by the exchange of energy with the environment. This behavior substantially depends on the flow velocity of the exhaust gases which is approximated by the air-mass flow. An abrupt change in the air mass signal occurs at the exhaust gas temperature sensor only after a delay or dead time. It is preferred for this delay or dead time to depend on the engine speed. This effect is taken into account by means of a dead-time and/or delay element. Moreover, the sensor behavior depends on the current temperature level because the response of the sensor is dependent on the temperature.

The steady-state final value of the temperature is mainly determined by the operating point. The operating point is preferably determined by injection quantity QK and the speed of the internal combustion engine N. In case of abrupt changes in these quantities, temperature correction values are determined which correct the current signal of the temperature sensor. In the process, the inertia and lag of the changes are also taken into account by means of filtering.

This filtering essentially includes a delay element and/or a dead-time element.

According to the present invention, correction factors are calculated which take both influences into account. The calculated correction values are limited to a useful level.

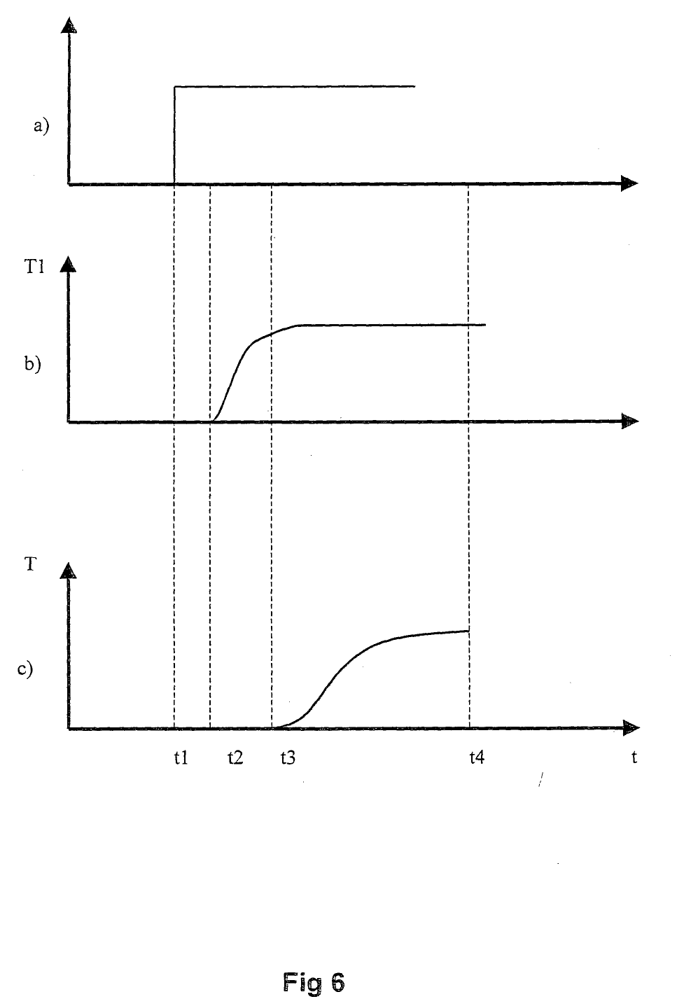

The procedure will be described by the example of an exhaust gas aftertreatment system. However, the proposed correction can also be used in the case of other temperature variables, in particular, the temperature of the air which is fed to the internal combustion engine. In FIG. 6, different variables are plotted over time t. A variable which characterizes the operating state of the internal combustion engine is plotted in partial FIG. 6a. This variable changes abruptly at instant t1. Injected fuel quantity QK is plotted as an example.

This abrupt increase in the fuel quantity causes an increase in the actual temperature in exhaust pipe 110. This actual temperature T1 is plotted in partial FIG. 6b. Changes in the operating state have an effect on temperature T1 only after a delay and/or a dead time. This means that actual temperature T1 increases only after a first dead time with a first delay.

This increase in temperature has an effect on temperature signal T only after a delay and/or a dead time. This means that temperature signal T increases only after a second dead time with a second delay.

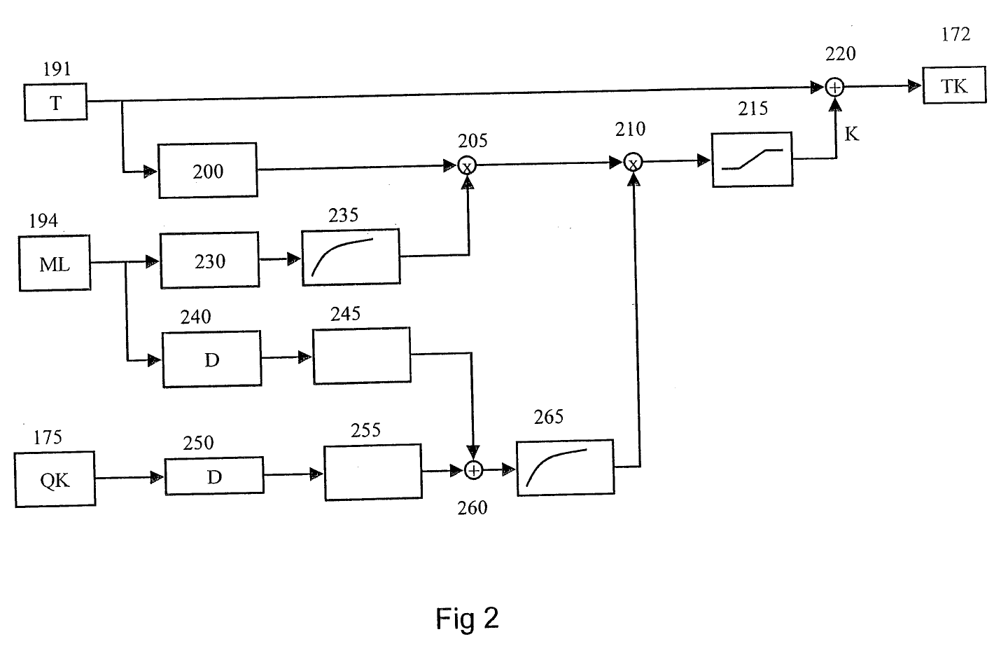

FIG. 2 shows a first embodiment of the procedure according to the present invention. Elements which have already been described in FIG. 1 are denoted by corresponding reference symbols. Sensor 191 delivers a signal T which characterizes the temperature of the exhaust gas in exhaust pipe 110. This signal reaches, first of all, a first characteristic curve 200 and a node 220. The output signal of first characteristic curve 200 reaches a node 210 via a node 205. The output signal of node 210 reaches the second input of node 220 via a limiter 215. The corrected temperature signal is available at the output of node 220, and is then able to be further processed by control 172.

Output signal ML of sensor 194, which characterizes the air mass fed to the internal combustion engine, reaches a second characteristic map 230 and a differentiator 240. The output signal of second characteristic map 230 reaches the second input of node 205 via a delay element 235. The output signal of differentiator 240 reaches a third characteristic map 245. The output signal of third characteristic map 245 reaches a node 260.

A signal with respect to injected fuel quantity QK, which is provided by control 175, gets via a differentiator 250 to a fourth characteristic curve 255 and from there to the second input of node 260. The output signal of node 260 reaches the second input of node 210 via a delay element 265.

Delay elements 235 and 265 are preferably designed as delay element(s) and/or dead-time element(s) whose delay time preferably depends on speed N of the internal combustion engine.

Nodes 205 and 210 preferably cause the signals to be multiplicatively combined and nodes 220 and 260 preferably result in an additive combination.

First characteristic curve 200 takes into account the temperature-dependent response of sensor 191 and the non-linearities thereof. This characteristic curve 200 provides a correction signal which compensates for these effects. The correction values in questions here are preferably predetermined by the sensor manufacturer.

Second characteristic curve 230 takes into account the heat transfer from the exhaust gas to the sensor. This characteristic curve allows for the fact that an increased air-mass flow cools down or warms up the sensor more strongly than a smaller air-mass flow. Moreover, delay element 235 takes into account that changes of the air mass that are measured on the intake side of the engine take effect in the exhaust branch only after a certain delay time and/or dead time. The correction values in question here are preferably determined on a test stand.

The signal present at the output of delay element 235 takes into account the heat transfer from the exhaust gas to the sensor. Together with characteristic curve 200, a correction is carried out which allows for the non-linear behavior of the sensor.

Differentiating element 240 determines a signal which characterizes the change in air mass ML. Correspondingly, differentiator 250 determines a signal which characterizes the change in injected fuel quantity QK. Third and fourth characteristic curves 245 and 255 each calculate a correction value from this change. This correction values compensates for the time lag characteristics of the internal combustion engine and/or of the associated components such as the exhaust gas aftertreatment system. The correction values in question here are preferably determined on a test stand.

This correction value generated in this manner is subsequently adapted by delay element 265 to the dynamic behavior of the internal combustion engine or of the associated components.

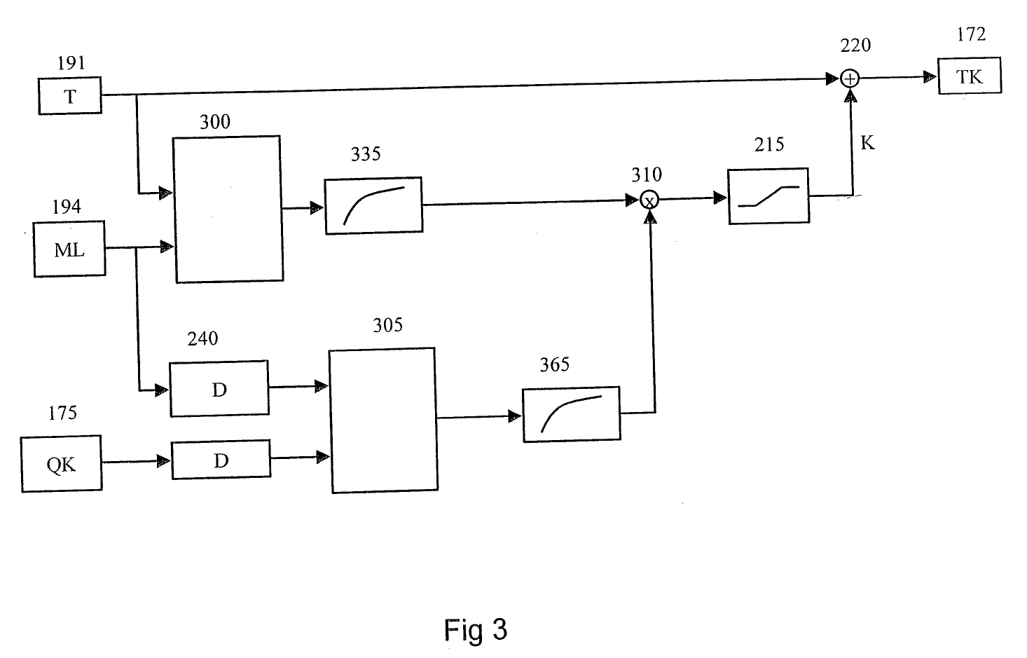

FIG. 3 shows a further embodiment of the correction. Elements which have already been described in FIGS. 1 and 2 are denoted by corresponding reference symbols.

The output signals of sensor 191 and sensor 194 reach a first characteristic map 300. The output signal thereof reaches a node 310 via a delay element 335. The output signals of differentiating elements 240 and 250 reach a second characteristic map 305 whose output signal reaches the second input of node 310 via a delay and/or dead-time element 365. The output signal of node 310 is applied to limiter 215.

This embodiment differs from the embodiment of FIG. 2 mainly in that characteristic curves 200 and 230 are combined into characteristic map 300, delay element 335 essentially corresponding to delay element 235. Correspondingly, characteristic curves 245 and 255 are combined into characteristic map 305. In this context, delay element 365 corresponds to delay element 265. Node 310 corresponds to node 210 of FIG. 2.

The correction values characterizing the behavior of temperature sensor 191 are stored in first characteristic map 300 which, moreover, takes into account the heat transfer from the exhaust gas to the sensor or vice verse as well as non-linearities. In this context, delay element 335 takes into account the dynamic behavior.

Second characteristic map 305 takes into account the quantity and air changes which cause a change in the steady-state value of the temperature signal. The delay element 365 corresponds to the dynamic behavior of the internal combustion engine or of the associated components.

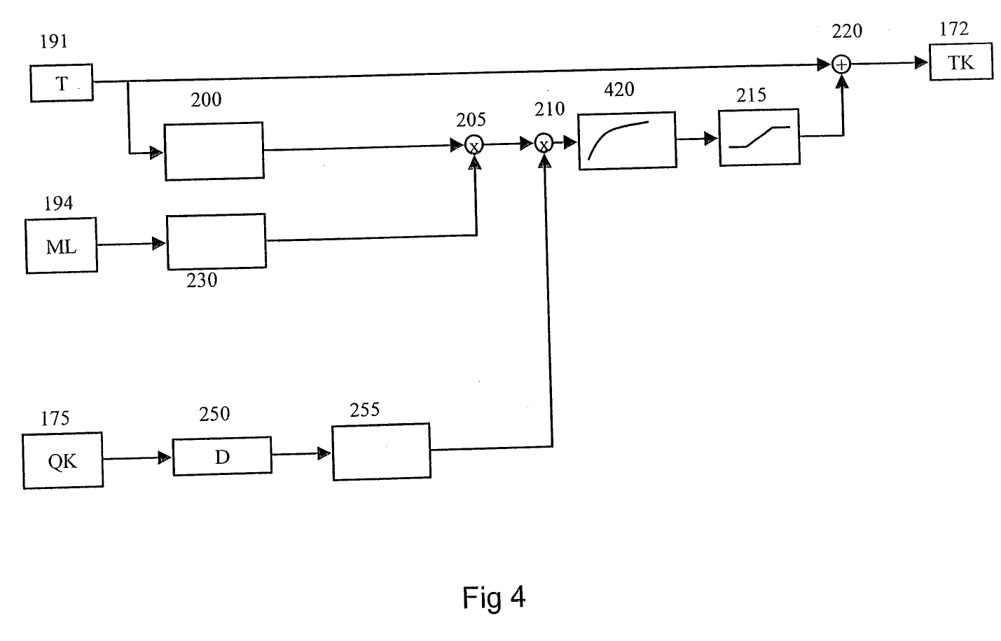

A further embodiment is shown in FIG. 4. Elements which have already been described in FIGS. 2 and 1 are denoted by corresponding reference symbols. The embodiment shown in FIG. 4 represents a simplified implementation of the embodiment according to FIG. 2. This embodiment differs from the embodiment according to FIG. 2 mainly in that differentiating element 240 and third characteristic curve 245 are dispensed with and in that delay elements 235 and 265 are combined into one delay element 420 which is arranged immediately upstream of the limiter and altogether delays the correction signal. This embodiment is simplified because the influence of the air mass is taken into account only with the effect on the heat transfer from the exhaust gas to the sensor.

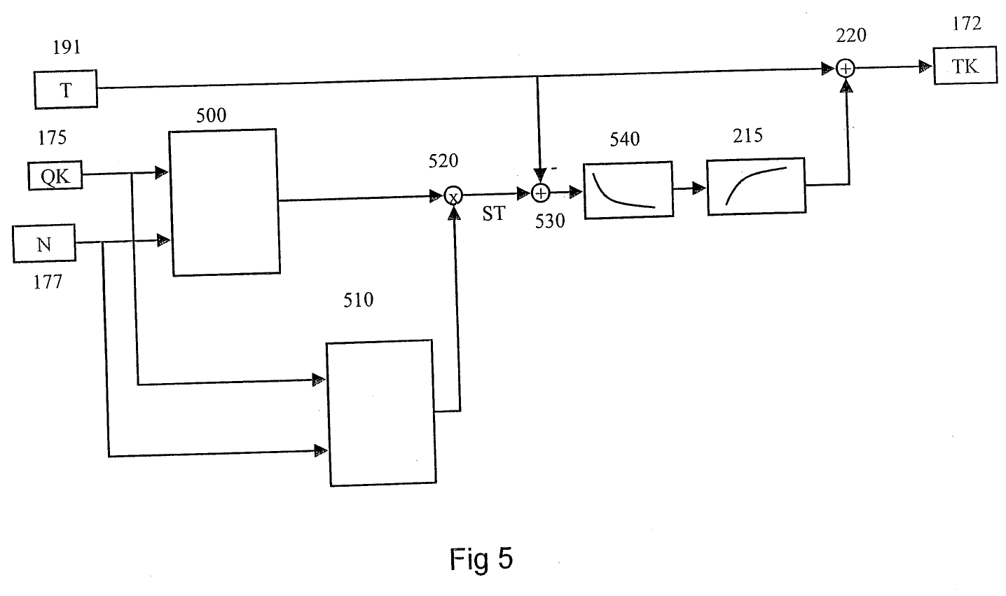

FIG. 5 depicts a further embodiment. Elements which have already been described in earlier Figures are denoted by corresponding reference symbols.

A signal with respect to injected fuel quantity QK and a signal with respect to the speed are fed to a third characteristic map 500 and to a fourth characteristic map 510. These two characteristic maps apply signals to a node 520 which, in turn, applies to a node 530. Signal T of the sensor is present at the second input of node 530. The output signal of node 530 gets via a DT1 element and a delay/dead-time element 215 to node 220 at whose first input is present signal T of the sensor.

The steady-state setpoint temperature at the given operating states, which are defined by speed N and injected fuel quantity QK, is stored in first characteristic map 500. This steady-state setpoint temperature characterizes the temperature which is reached in the stationary state given the performance characteristics. Stored in second characteristic map 510 is the loss factor which indicates the temperature loss due to different influences. These values are also stored as a function of the operating point.

Steady-state temperature ST to be expected is calculated by node 520 on the basis of the two values which are read out from the characteristic maps. The node compares this temperature ST to measured temperature T. The deviation resulting therefrom is dynamically processed. This is preferably accomplished by DT1 element 540 and delay element 215.

In an advantageous embodiment, the time constants of delay elements 540 and 215 are selectable by the exhaust gas mass flow. Alternatively to the exhaust gas mass flow, it is also possible to use speed N of the internal combustion engine and/or air quantity ML.

It is particularly advantageous that a substitute value is available in case of a defect of sensor 191. In case of a defect, temperature value ST is used as a substitute value.

What is claimed is:

1. A method for correcting a temperature signal, in particular, a temperature signal which characterizes the temperature of the gases which are fed to the internal combustion engine and/or which are emitted by the of an internal combustion engine, a first correction being carried out which takes into account the response of the sensor, and a second correction being carried out which takes into account the dynamic behavior of the internal combustion engine and/or of the associated components.

2. The method as recited in claim 1,
wherein
a correction value is selectable which is used, in particular, to correct the response of the sensor.

3. The method as recited in claim 2,
wherein
the correction value is selectable as a function of a temperature and/or as a function of an air quantity.

4. The method as recited in one of the preceding claims,
wherein
a correction value is used to correct the delay time of the overall system during changes of the operating state (QK, ML).

5. The method as recited in claim 4,
wherein
the correction value is selectable as a function of a fuel quantity, an air quantity and/or of a rotational speed.

6. The method as recited in one of the preceding claims,
wherein
the correction value(s) is/are limited.

7. The method as recited in one of the preceding claims,
wherein
the correction value(s) is/are fed to a delay element.

8. The method as recited in one of the preceding claims,
wherein
provision is made for a substitute value for the sensor signal.

9. A device for correcting a temperature signal, in particular, a temperature signal which characterizes the temperature of the gases which are fed to the internal combustion engine and/or which are emitted by the of an internal combustion engine, comprising means which carry out a first correction which takes into account the response of the sensor and a second correction which takes into account the dynamic behavior of the internal combustion engine and/or of the associated components.
